(19) United States
(12) Patent Application Publication
(10) Pub. No.: US 2020/0096138 A1
(43) Pub. Date: Mar. 26, 2020

(54) CONVERTER BULKHEAD FITTING

(71) Applicant: PHILLIPS CONNECT TECHNOLOGIES LLC, Santa Fe Springs, CA (US)

(72) Inventors: Adam Bean, Hacienda Heights, CA (US); Douglas Chambers, San Pedro, CA (US); Ruben Chicas, San Pedro, CA (US)

(21) Appl. No.: 16/141,684

(22) Filed: Sep. 25, 2018

(51) Int. Cl. F16L 5/00; F16L 19/00

(52) U.S. Cl. CPC F16L 5/00; F16L 19/00

(57) ABSTRACT

A fitting for coupling a first conduit with a second conduit includes a body member including a first threaded portion at a first end of the body member, the first threaded portion having a first external thread and defined internally by a through-bore, a second threaded portion at a second end of the body member, the second threaded portion having a second external thread and defined internally by the through-bore, the second threaded portion being configured to engage the second conduit, and a third threaded portion between the first and second threaded portions, a first nut member and a second nut member, each having internal threads configured to mate with threads of the third threaded portion, the internal threads being complementary with threads of the third threaded portion, and a compression fit assembly configured to be in threaded association with the first external thread and to form a sealing engagement with the first conduit, wherein the first, second, and third threaded portions of the body member are monolithically formed.

### FIELD

The present invention relates to the field of tube fittings.

### BACKGROUND

Tube fittings are generally used to connect one section of a tube to another tube, pipe, or equipment. Tube fittings commonly include connectors, unions, and bulkhead fittings. Bulkhead fittings are designed to fit through holes in panels or enclosures to provide a way for a fluid/air line to pass through the panel or enclosure. Currently, in order to design a bulkhead fitting that couples together different types of tubes/pipes, it may be required to join a number of disparate components through, for example, a number of screw mechanisms. However such an assemblage of components may be susceptible to loosening, leakage, and even breakage, and assembly options may be limited due to space constraints.

The above information disclosed in this Background section is only for enhancement of understanding of the background of the invention and therefore may contain information that does not form the prior art that is already known to a person of ordinary skill in the art.

### SUMMARY

Aspects of embodiments of the present invention are directed to a fitting for fixedly coupling together different conduits at opposite sides of a wall. In some embodiments, the fitting is a converter bulkhead fitting that couples together a standard national pipe thread (NPT) compatible conduit, at one end, and a straight-end tube at another end, and forms a tight seal with the bulkhead.

According to some embodiments of the present invention, there is provided a fitting for coupling a first conduit with a second conduit, the fitting including: a body member including: a first threaded portion at a first end of the body member, the first threaded portion having a first external thread and defined internally by a through-bore; a second threaded portion at a second end of the body member, the second threaded portion having a second external thread and defined internally by the through-bore, the second threaded portion being configured to engage the second conduit; and a third threaded portion between the first and second threaded portions; a first nut member and a second nut member, each having internal threads configured to mate with threads of the third threaded portion, the internal threads being complementary with threads of the third threaded portion; and a compression fit assembly configured to be in threaded association with the first external thread and to form a sealing engagement with the first conduit, wherein the first, second, and third threaded portions of the body member are monolithically formed (i.e., (i.e., integrally formed).

In some embodiments, a diameter of the third threaded portion is greater than that of any other portion of the body member, and a threaded length of the third threaded portion is greater than a combined thickness of the first and second nut members and a wall through which the body member is configured to pass.

In some embodiments, the third threaded portion is entirely threaded along its length to permit the first and second nut members to travel along an entire length of the third threaded portion.

In some embodiments, the body member further includes: a first tool engagement portion between the first and third threaded portions; and a second tool engagement portion between the second and third threaded portions, the third threaded portion having a third external thread and defined internally by the through-bore, wherein each of the first and second tool engagement portions is configured to be engaged by a tool.

In some embodiments, the first and second tool engagement portions of the body member are monolithically formed (i.e., integrally formed) with other portions of the body member.

In some embodiments, the compression fit assembly includes: a compression nut member having internal threads configured to be in threaded association with the first external thread for selective advancement and withdrawal of compression nut member relative to the body member in response to rotation of the compression nut member relative to the body member; and a ferrule between the first threaded portion and the compression nut member and configured to press against the first conduit to form a sealing engagement with the first conduit in response to advancement of the compression nut member toward the first threaded portion.

In some embodiments, an axially inner end portion of the first threaded portion is radially inwardly defined by a first cam surface that is an axially inwardly narrowing frusto-conical surface, and an axially inner end portion of the compression nut member is radially inwardly defined by a second cam surface that is an axially outwardly narrowing frusto-conical surface.

In some embodiments, the ferrule is configured to engage the first and second cam surfaces such that, upon advancement of the compression nut member toward the body member, the ferrule is constricted into a sealing engagement with the first conduit.

In some embodiments, the body member further includes a guide tube fixedly coupled to an interior of the body member and having a hollow interior forming part of the through-bore, and as the compression nut member advances toward the body member, the ferrule presses the first conduit against an outer portion of the guide tube and forms a seal between first conduit and the body member.

In some embodiments, the compression nut member has a plurality of flats at its exterior configured for engagement by a tool.

In some embodiments, the second threaded portion has a tapered threading.

In some embodiments, each of the first and second nut members have a plurality of flats for engagement by a tool.

In some embodiments, the fitting further includes a first gasket and a second gasket, the first and second gaskets being configured to seal junctions between the first and second nut members and a wall through which the body member passes.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be illustrative only.

FIG. 1 illustrates the coupling of first and second conduits on opposite sides of a bulkhead via a fitting, according to some exemplary embodiments of the present invention.

FIGS. 2A-2B are perspective views of the fitting in assembled form from two different angles, according to some exemplary embodiments of the present invention.

FIGS. 3A-3B are side and perspective views, respectively, of the fitting in unassembled form, according to some exemplary embodiments of the present invention.

FIG. 4A illustrates a cross-sectional view of the fitting, according to some embodiments of the present invention.

FIG. 4B illustrates an enlarged view of the section AA′ of FIG. 4A.

### DETAILED DESCRIPTION

The detailed description set forth below in connection with the appended drawings is intended as a description of illustrative embodiments of a smart trailer in accordance with the present invention, and is not intended to represent the only forms in which the present invention may be implemented or utilized. The description sets forth the features of the present invention in connection with the illustrated embodiments. It is to be understood, however, that the same or equivalent functions and structures may be accomplished by different embodiments that are also intended to be encompassed within the spirit and scope of the present invention. As denoted elsewhere herein, like element numbers are intended to indicate like elements or features.

Aspects of the present invention are directed to a fitting (e.g., a converter bulkhead fitting) for coupling together two different conduits (e.g., tubes of different type) at opposite sides of a wall (e.g., a panel or bulkhead). The fitting may have a tapered thread (e.g., a standard national pipe thread (NPT)) on one end and a compression-style tube fitting on the other end. The fitting may provide a way for an air or fluid line to pass through an opening (e.g., a hole) in the wall. The outer diameter of the fitting may be mostly threaded, and no portion of the monolithic (i.e., integrally formed) fitting body may be larger than the outer threaded diameter, thus allowing the fitting to be installed from either side of the wall (e.g., bulkhead). Further, two hex nuts, which match the outer diameter thread of the monolithic fitting body, may be utilized along with one or more seals to create an air-tight or water-tight seal at the passthrough of the wall.

According to some examples, the fitting may be utilized to couple together an air valve within an airlock box of a vehicle (e.g., a trailer), and an air tubing that is external to the airlock box. The fitting may provide airflow to the airlock box, which operates the brakes of the vehicle (by, e.g., locking and unlocking the brakes). However, embodiments of the present invention are not limited thereto, and the fitting, according to embodiments of the present invention, may be used in any suitable application.

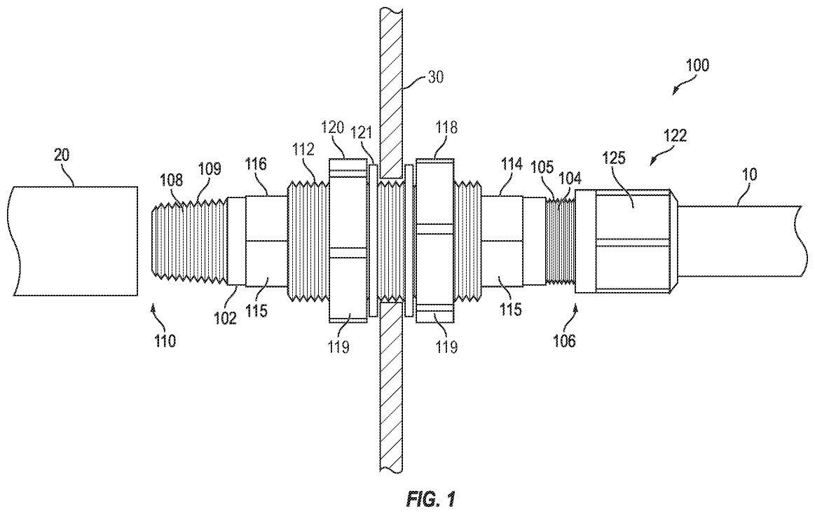

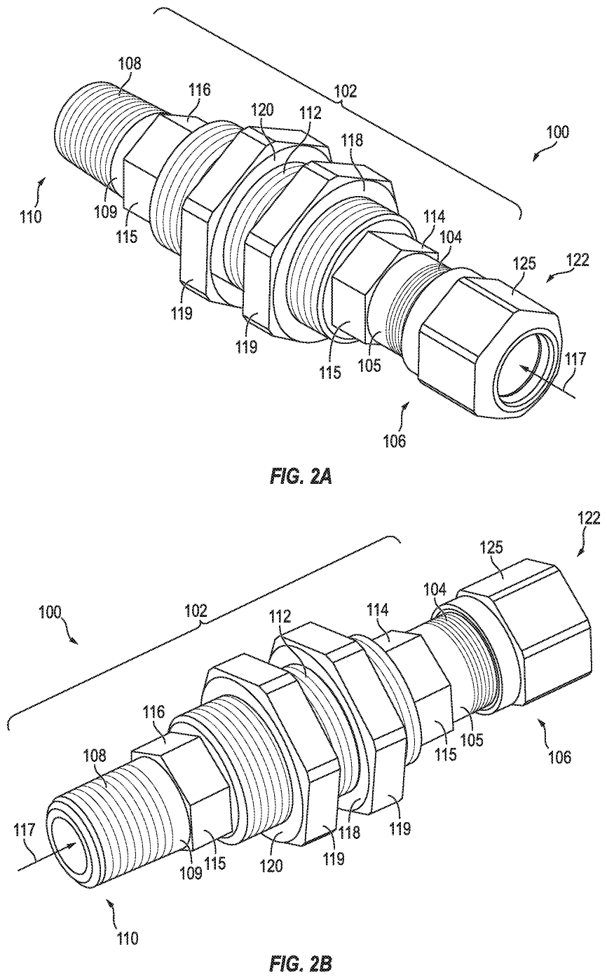

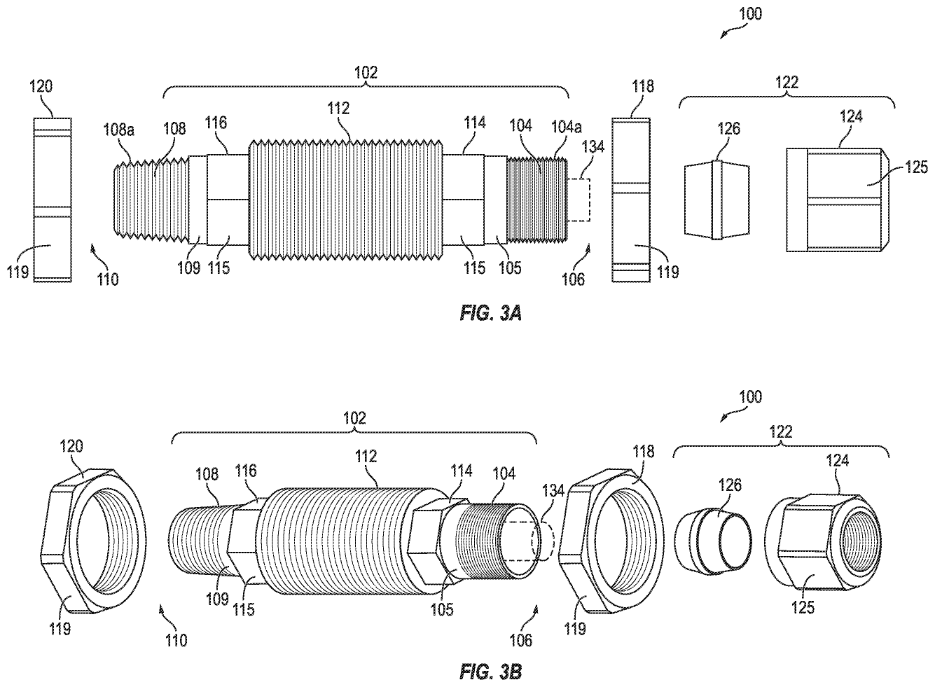

FIG. 1 illustrates the coupling of first and second conduits 10 and 20 on opposite sides of a bulkhead 30 via a fitting 100, according to some exemplary embodiments of the present invention. FIGS. 2A-2B are perspective views of the fitting 100 in assembled form from two different angles, according to some exemplary embodiments of the present invention. FIGS. 3A-3B are side and perspective views, respectively, of the fitting 100 in unassembled form, according to some exemplary embodiments of the present invention.

Referring to FIG. 1, the fitting (e.g., the adjustable tube fitting) 100 is configured to couple together first and second conduits (e.g., straight-end tubes) 10 and 20 that are at opposite sides of a wall (e.g., a bulkhead or panel) 30. In some examples, the wall 30 may be part of a panel/bulkhead or an enclosure, such as an airlock box of a vehicle (e.g., a trailer, which manages airflow to the braking system of the vehicle. In some embodiments, the fitting 100 functions as a converter bulkhead fitting for coupling together the first and second conduits 10 and 20 of different type. For example, the first conduit 10 may be a hard or soft tube suitable for compression fitting, and the second conduit 20 may have a tapered threading (e.g., an NPT compatible threading) and be a rigid tube (e.g., a straight-end tube), a rigid tubing elbow (e.g., a metal elbow connector), or the like.

Referring to FIGS. 1 and 2A-2B, according to some embodiments, the fitting 100 includes a body member (e.g., a monolithic body) 102, which includes a first threaded portion 104 having a first external thread 104a at a first end 106 of the body member 102, a second threaded portion 108 having a second external thread 108a at a second end 110 of the body member 102, and a third threaded portion 112 having a third external thread 112a formed between the first and second threaded portions 104 and 108. The threads of each of the threaded portions 104, 108, and 112 may be standard or metric threads, as suitable. In some embodiments, the body member 102 further includes a first tool engagement portion 114 between the first and third threaded portions 104 and 112, and a second tool engagement portion 116 between the second and third threaded portions 108 and 112. In some examples, each of the first and second tool engagement portions 114 and 116 may be provided exteriorly with a plurality of flats 115 for engagement by a suitable tool such as a wrench (not shown).

In some examples, a first unthreaded portion 105 may reside between the first threaded portion 104 and the third threaded portion 112, and a second unthreaded portion 109 may reside between the second threaded portion 108 and the third threaded portion 112. In some examples, the unthreaded portion 105/107 may have substantially the same diameter as the corresponding threaded portion 104/108. The first and second unthreaded portions 105 and 109 may act as screw stops limiting the advancement of the coupling element when torqued against the first and second threaded portions 104 and 108, respectively. However, embodiments of the present invention are not limited thereto, and at least one of the first and second threaded portions 104 and 108 may abut the third threaded portion 112.

The body member 102 is defined internally by a through bore (e.g., a through hole) extending axially along the length of the body member 102, which allows for fluid communication between the first conduit 10 and the second conduit 20. According to some embodiments, the first, second, and third threaded portions 104, 108, and 112 are monolithically formed (i.e., integrally formed) as a single body (e.g., formed without joints or seams) and of the same material. The body member 102 may be made of any suitable material, such as steel, stainless steel, brass, bronze, cast iron, aluminum, zinc, an alloy thereof, a suitably strong plastic, and/or the like.

The fitting 100 further includes a first nut member 118 and a second nut member 120, each having internal threads that are complementary with the third external thread 113 of the of the third threaded portion 112 and is arranged for selective advancement and withdrawal of the nut member 118/120 relative to the body member 102 based on rotation of the nut member 118/120 relative to the body member 102. The nut member 118/120 may have a plurality of flats 119 for engagement by a suitable tool such as a wrench (not shown). When properly torqued, the first and second nut members 118 and 120 allow the fitting 100 to become fixedly coupled to the wall 30.

In some embodiments, the third threaded portion 112 is either entirely threaded along its length or has one or more unthreaded portions (e.g., at one or more of its axial ends) that have diameters less than or substantially the same as that of the threaded portion. This allows each of the first and second nut members 118 and 120 to advance the entire length of the third threaded portion 112 in either direction, when torqued. Further, according to some embodiments, the outer diameter of the third threaded portion 112 is greater than that of each of the first and second threaded portions 104 and 108. In some examples, the body member 102 may be about 2.5 inches in length (i.e., along the axial direction of the fitting 100), the third threaded portion 112 may be about 1 inch in length (i.e., along the axial direction of the fitting 100), the first and second tool engagement portions 114 and 116 may each be about 0.3 inches in length, and the through-hole 117 may have a diameter of about 0.3 inches. In some examples, the first threaded portion 104 may have a 17/32-24 UNS (Unified National Special) threading, the second threaded portion 108 may have a ¼″ NPT (National Pipe Thread) threading, and the third threaded portion 112 may have a ¾-16 UNF (Unified National Fine) threading. As such, when the body member 102 is inserted through an opening in the bulkhead, to which the fitting 100 is to be fixed, each of the nut members 118 and 120 may approach and engage the third threaded portion 112 from either of the first end 106 or second end 110 of the body member 102, that is, from either side of the wall 30. This simplifies the process of fixing the fitting 100 to the wall 30. However, embodiments of the present invention are not limited thereto, and in some examples, one end of the third threaded portion 112 may have a screw stop portion (e.g., an unthreaded portion) with a diameter greater than that of the threads of the third threaded portion 112, which may prevent the nut members 118 and 120 from engaging/disengaging the third threaded portion 112 from that end.

In some embodiments, a gasket/seal 121 may be used to seal the junction between each of the first and second nut members 118 and 120 and the wall 30. This may produce a tight seal (e.g., an air-tight and/or water-tight seal) at the passthrough of the wall 30. In some embodiments, in lieu of the gasket/seal 121, a suitable locking mechanism (e.g., a lock washer) may be placed between the wall 30 and each of the first and second nut members 118 and 120 to prevent each of the first and second nut members 118 and 120 from turning and coming loose due to vibrations or torque. However, embodiments of the present invention are not limited thereto, and rather than use a separate locking mechanism, one or more of the first and second nut members 118 and 120 may be a lock nut (or a prevailing torque nut or elastic stop nut), which resist loosening under vibrations and torque.

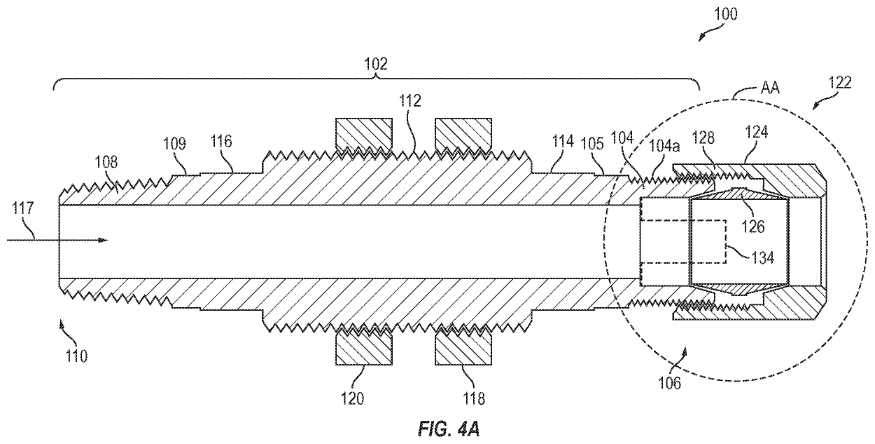

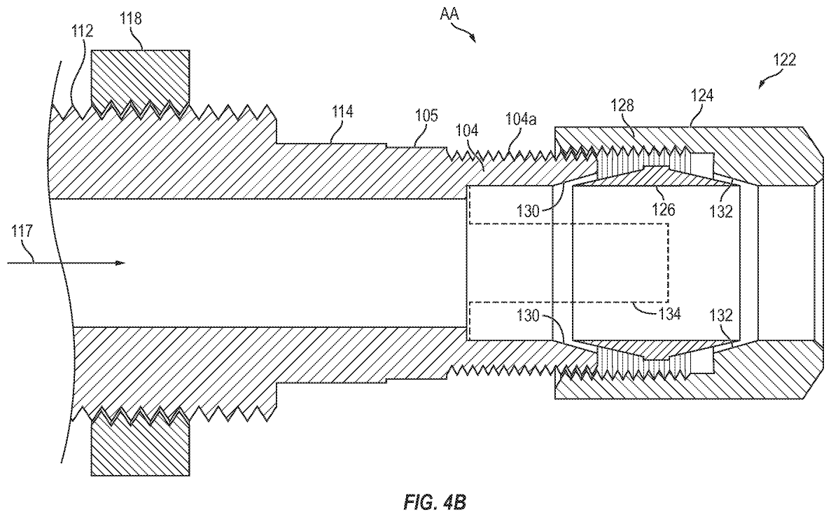

FIG. 4A illustrates a cross-sectional view of the fitting 100, according to some embodiments of the present invention. FIG. 4B illustrates an enlarged view of the section AA′ of FIG. 4A.

Referring to FIGS. 4A-4B, in some embodiments, the first end 106 of the body member 102 is coupled to the conduit 10 via a compression fit assembly 122 including a compression nut member 124 and a ferrule 126. Referring to FIG. 4B, the compression nut member 124 may include an axial sleeve portion 128 having internal threads configured to be in threaded association with the first external thread 104a for selective advancement and withdrawal of compression nut member 124 relative to the body member 102 in response to rotation of the compression nut member 124 relative to the body member 102. The compression nut member may have a plurality of flats 125 at its exterior configured for engagement by a suitable tool (e.g., a wrench).

In some examples, the axially inner end portion of the first threaded portion 104 is radially inwardly defined by a first cam surface 130 that is an axially inwardly narrowing frusto-conical surface, and the axially inner end portion of the compression nut member 124 is radially inwardly defined by a second cam surface 132 that is an axially outwardly narrowing frusto-conical surface. The ferrule 126 may be located between the first threaded portion 104 and the compression nut member 124 and be configured to engage the first and second cam surfaces 130 and 132, such that, upon advancement of the compression nut member 124 toward the body member 102, the ferrule 126 is constricted into sealing/supporting engagement with the first conduit 10.

In some examples, the first conduit 10 is a rigid tube (e.g., a metallic tube), and the constriction of the ferrule sealingly couples the first conduit 10 to the body member 102. In other examples, the first conduit 10 may be formed of a soft material, such as flexible nylon, and the constriction of the ferrule alone may not be sufficient to form a sealed engagement. In such examples, the body member 102 may additionally include a guide tube 134, which is fixedly coupled to the interior of the body member 102 and has a hollow interior that forms part of the through-hole 117. The outer diameter of the guide tube 134 may be substantially the same as, or slightly less than, the inner diameter of the interior of the first conduit 10. Here, as the compression nut member 124 advances toward the body member 102, the ferrule 26 tightly presses the first conduit 10 against the outer portion of the guide tube 134 and forms a tight seal between first conduit 10 and the body member 102.

In some embodiments, the second threaded portion 108 is tapered for sealing (e.g., may have national pipe taper (NPT) threads). As such, when torqued, a seal may be formed between the second threaded portion 108 and the second conduit 20 by, for example, metal-to-metal wedging. However, embodiments of the present invention are not limited thereto, and in some examples, the second threaded portion 108 may have a parallel/straight thread, or be a compression fitting that is substantially similar to the compression fit assembly 122.

As the position of the second conduit 20 relative to the wall (e.g., bulkhead) 30 may be fixed, the threaded length of the third threaded portion 112, which is greater than the combined thickness of the first and second nut members 118 and 120 and the wall, allows a degree a flexibility in positioning the body member 102 relative to the wall during installation.

Accordingly, the fitting 100, according to some embodiments of the present invention, allows for easy installation on a bulkhead from either side of the bulkhead. This is due, in part, to the fact that (1) the body member 102 has its greatest diameter at its mid-section (i.e., at the third threaded portion 112); that (2) the third threaded portions allows for engagement of the first and second nut members 118 and 120 from either end of the fitting 100; and that (3) the fitting 100 has two tool engagement portions 114 and 116 at each end of the third threaded portion 112, which ease the process of tightening the nut members 118 and 120 on opposite sides of the bulkhead to form a seal (e.g., an air-tight/fluid-tight) at the bulkhead passthrough. Further, the monolithic, single-body, form of the body member 102 and the contiguous nature of the through-hole 117, according to some embodiments, provides a robust air/fluid pass line through the bulkhead that is far less susceptible to loosening, leakage, and even breakage (due to fewer weak points in assembly) than the conventional fittings that are assemblages of disparate components. Further, the fitting 100 has a greatly reduced assembly time as compared to the conventional fittings that require assembling multiple pieces together, sometimes under difficult spaced-constrained environments.

While the present invention has been particularly illustrated and described with reference to exemplary embodiments thereof, it will be understood by those of ordinary skill in the art that various suitable changes in form and detail may be made therein without departing from the spirit and scope of the present invention as defined by the following claims and equivalents thereof. The exemplary embodiments should be considered in a descriptive sense only and not for purposes of limitation.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

In addition, it will also be understood that when a component is referred to as being “between” two components, it can be the only component between the two components, or one or more intervening components may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the use of “may” when describing embodiments of the inventive concept refers to “one or more embodiments of the inventive concept.” Also, the term “exemplary” is intended to refer to an example or illustration.

It will be understood that when an element is referred to as being “on”, “connected to”, “coupled to”, or “adjacent” another element or layer, it can be directly on, connected to, coupled to, or adjacent the other element, or one or more intervening elements may be present. When an element is referred to as being “directly on,” “directly connected to”, “directly coupled to”, or “immediately adjacent” another element, there are no intervening elements present.

As used herein, the term “substantially,” “about,” and similar terms are used as terms of approximation and not as terms of degree, and are intended to account for the inherent variations in measured or calculated values that would be recognized by those of ordinary skill in the art. Further, a specific quantity or range recited in this written description or the claims may also encompass the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification.

What is claimed is:

1. A fitting for coupling a first conduit with a second conduit, the fitting comprising:
a body member comprising:
a first threaded portion at a first end of the body member, the first threaded portion having a first external thread and defined internally by a through-bore;
a second threaded portion at a second end of the body member, the second threaded portion having a second external thread and defined internally by the through-bore, the second threaded portion being configured to engage the second conduit; and
a third threaded portion between the first and second threaded portions;
a first nut member and a second nut member, each having internal threads configured to mate with threads of the third threaded portion, the internal threads being complementary with threads of the third threaded portion; and
a compression fit assembly configured to be in threaded association with the first external thread and to form a sealing engagement with the first conduit,
wherein the first, second, and third threaded portions of the body member are monolithically formed.

2. The fitting of claim 1, wherein a diameter of the third threaded portion is greater than that of any other portion of the body member, and
wherein a threaded length of the third threaded portion is greater than a combined thickness of the first and second nut members and a wall through which the body member is configured to pass.

3. The fitting of claim 1, wherein the third threaded portion is entirely threaded along its length to permit the first and second nut members to travel along an entire length of the third threaded portion.

4. The fitting of claim 1, wherein the body member further comprises:
a first tool engagement portion between the first and third threaded portions; and
a second tool engagement portion between the second and third threaded portions, the third threaded portion having a third external thread and defined internally by the through-bore,
wherein each of the first and second tool engagement portions is configured to be engaged by a tool.

5. The fitting of claim 4, wherein the first and second tool engagement portions of the body member are monolithically formed with other portions of the body member.

6. The fitting of claim 1, wherein the compression fit assembly comprises:
a compression nut member having internal threads configured to be in threaded association with the first external thread for selective advancement and withdrawal of compression nut member relative to the body member in response to rotation of the compression nut member relative to the body member; and
a ferrule between the first threaded portion and the compression nut member and configured to press against the first conduit to form a sealing engagement with the first conduit in response to advancement of the compression nut member toward the first threaded portion.

7. The fitting of claim 6, wherein an axially inner end portion of the first threaded portion is radially inwardly defined by a first cam surface that is an axially inwardly narrowing frusto-conical surface, and
wherein an axially inner end portion of the compression nut member is radially inwardly defined by a second cam surface that is an axially outwardly narrowing frusto-conical surface.

8. The fitting of claim 7, wherein the ferrule is configured to engage the first and second cam surfaces such that, upon advancement of the compression nut member toward the body member, the ferrule is constricted into a sealing engagement with the first conduit.

9. The fitting of claim 6, wherein the body member further comprises a guide tube fixedly coupled to an interior of the body member and having a hollow interior forming part of the through-bore, and
wherein as the compression nut member advances toward the body member, the ferrule presses the first conduit against an outer portion of the guide tube and forms a seal between first conduit and the body member.

10. The fitting of claim 6, wherein the compression nut member has a plurality of flats at its exterior configured for engagement by a tool.

11. The fitting of claim 1, wherein the second threaded portion has a tapered threading.

12. The fitting of claim 1, wherein each of the first and second nut members have a plurality of flats for engagement by a tool.

13. The fitting of claim 1, further comprising a first gasket and a second gasket, the first and second gaskets being configured to seal junctions between the first and second nut members and a wall through which the body member passes.
